(19) United States
(12) Patent Application Publication
(10) Pub. No.: US 2026/0203022 A1
(43) Pub. Date: Jul. 16, 2026

(54) MULTI-SOURCE RETRIEVAL AUGMENTED CODE GENERATION

(71) Applicant: International Business Machines Corporation, Armonk, NY (US)

(72) Inventors: Xiaojie Guo, Burke, VA (US); Michael Robert Glass, Bayonne, NJ (US); Saurabh Pujar, White Plains, NY (US); Alessandro Morari, New York, NY (US); Luca Buratti, Long Island City, NY (US)

(21) Appl. No.: 19/016,351

(22) Filed: Jan. 10, 2025

(51) Int. Cl. G06F 8/30

(52) U.S. Cl. CPC G06F 8/30

(57) ABSTRACT

Mechanisms are provided for automatically generating source code to perform an intended code functionality. The mechanisms create a pairwise data source as a pairwise retrieval pool, where each data sample includes a pairing of a textual description and a corresponding relevant source code snippet. The mechanisms comprise an encoder that encodes an input natural language text description of an intended code functionality, to thereby generate an input encoding. The mechanisms search the pairwise retrieval pool for one or more candidate data samples based on the input encoding and encodings of the textual descriptions of the data samples. The mechanisms select a candidate data sample and generate the output source code based on the selected candidate data sample and the input natural language text description.

### BACKGROUND

The present application relates generally to a data processing apparatus and method and more specifically to a computing tool and computing tool operations/functionality for multi-source retrieval augmented code generation.

Code generation is an important field involving the prediction of explicit program code given a natural language instruction or description of what that code is intended to do. For example, given a natural language input of the type “Sum the first two elements in tmp”, a code generation tool may generate the code “np.sum(tmp[:2])”. Code generation tools can assist the development of automatic programming tools and improve programming productivity by allowing users to describe the functionality that they wish to implement in more natural language descriptions and have computer executable code automatically generated for them that can be used to cause the computing device to perform the requested function.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises creating a pairwise data source as a pairwise retrieval pool, wherein each data sample includes a pairing of a textual description and a corresponding relevant source code snippet. The method further comprises encoding, via an encoder, an input natural language text description of an intended code functionality, to thereby generate an input encoding. The method also comprises searching the pairwise retrieval pool for one or more candidate data samples based on the input encoding and encodings of the textual descriptions of the data samples. In addition, the method comprises selecting a candidate data sample from the one or more candidate data samples for use in generating output source code. Furthermore, the method comprises generating the output source code based on the selected candidate data sample and the input natural language text description.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example conceptual diagram of an operation of a first type of retrieval-augmented code generator;

FIG. 1B is an example conceptual diagram of an operation of a second type of retrieval-augmented code generator that retrieves reference documents/instructions;

FIG. 1C is an example conceptual diagram of an operation of a multi-source retrieval-augmented code generator in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example block diagram of a multi-source retrieval-augmented code generator in accordance with one illustrative embodiment; and

FIG. 4 is an example flowchart outlining an example operation of a multi-source retrieval-augmented code generator in accordance with one illustrative embodiment.

### DETAILED DESCRIPTION

The illustrative embodiments provide an improved computing tool and improved computing tool operations/functionality for multi-source retrieval augmented code generation. The illustrative embodiments perform retrieval-augmented code generation using a plurality of sources of information including pairwise correlations of reference codes and reference instructions/documentation providing context sensitive reference examples, as well as documents providing higher level guidance, such as program language tutorial documentation, guidelines, and best practices documentation. The higher level documentation provides a basis for ranking the context sensitive reference examples to identify higher quality examples for use in automatically generating computer executable code from natural language descriptions of computer code functionality. Moreover, by combining these multiple sources of knowledge, it is more likely that the illustrative embodiments may accurately handle edge cases or uncommon scenarios.

Code generation tools attempt to translate natural language descriptions into generated code. Such code generation tools comprise artificial intelligence (AI) computer models that are trained on training datasets to output a computer executable code based on an input of a natural language statement. The AI computer model performs natural language processing of the input and attempts to match the input natural language elements to code elements in the training examples.

Such code generation tools are limited in that they only work well for inputs that are similar to the training examples that they were trained on. That is, if an input natural language statement of computer code functionality sufficiently differs from the training examples used to train the code generation tool, then the code generation tool will output poor results. This is a significant problem when one considers that the code that is output may cause serious problems when execution is attempted, not only with regard to the particular generated code, but other code that may be executing on the computing system. In addition, language models can “hallucinate” code that appears correct but is not functional or aligned with the intended use. For example, the language model might invent a function or class that does not exist in a library.

To address these limitations of code generation tools, retrieval-augmented code generation may be utilized. Retrieval-augmented code generation involves retrieving reference data from an outside knowledge base to assist in the code generation process. Retrieval-augmented code generation tools are similar to code generation tools, but further leverage reference information to make determinations as to how to translate natural language descriptions of computer functionality into computer executable code. Retrieval mechanisms can fetch up-to-date information, such as new library usage, API documentation, or code examples, to fill in the gaps between training and real input instructions dynamically during generation. As a result, the retrieval-augmented code generation tools have higher accuracy than code generation tools as they are able to leverage the knowledge from the outside source. For example, retrieval-augmented code generation tools can reduce “hallucination” by grounding the generation in retrieved code references, ensuring validity and accuracy.

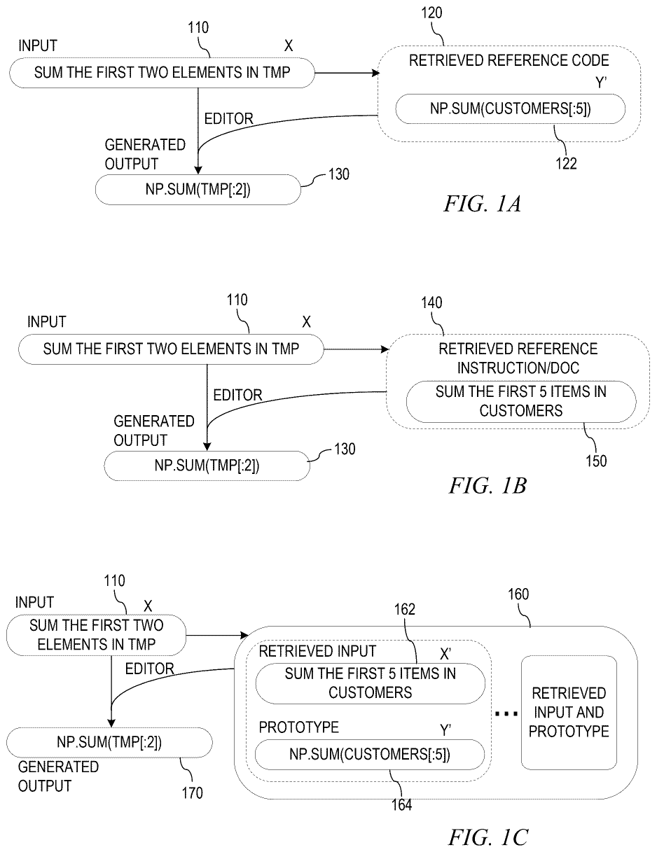

Retrieval-augmented code generation may be categorized into two separate types of tools based on the outside knowledge resources utilized. FIG. 1A is an example conceptual diagram of an operation of a first type of retrieval-augmented code generator in which the outside knowledge base is comprised of reference code snippets. The retrieval-augmented code generation of this first type involves directly finding reference code snippets that are relevant to the key terms used in the input natural language specification of the intended computer functionality. That means, in this way, the retrieval process is based on finding the similarity between natural language and program language (code snippets). That is, as shown in FIG. 1A, an input x 110 is received that has a natural language description of a function that the resulting source code is to perform, e.g., “sum the first two elements in tmp”. The key terms in this input 110 may be used to search the code snippets in an outside knowledge base 120 to find those that have a sufficient level of similarity. The corresponding code snippet y′ 122 may then be used as a template by a code editor to generate the source code output y 130 based on the other elements specified in the input 110, e.g., first two elements and tmp. In the example of FIG. 1A, the data structure “Customer” in the reference code snippet y′ 122 is replaced with the “tmp” referenced in the input 110, and the element designation “[:5]” is replaced with “[:2]” in accordance with the statement in the input 110 to sum the “first two elements”, to thereby generate the source code output y 130. It should be noted that there is a mismatch challenge between the code and natural language since they have different representational systems.

FIG. 1B is an example conceptual diagram of an operation of a second type of retrieval-augmented code generator in which the outside knowledge base is comprised of reference documents and natural language specified instructions similar to the input of the natural language. The retrieval-augmented code generation of this second type involves finding reference natural language descriptions in the outside knowledge base 140 that are similar to the key terms used in the input natural language specification of the intended computer functionality, i.e., input x 110. Thus, for example, if the input 110 is “sum the first two elements in tmp”, the key terms in this input 110 may be used to search natural language documents and instructions 140 to find those that are sufficiently similar, e.g., entry “sum the first 5 items in Customers” 150 is similar to the input natural language description of the desired source code 110. The language models may then capture the semantic meanings of the input natural languages and generated the code based on the semantic understanding of the input.

However, even with this retrieval-augmented code generation, the input natural language, as well as the retrieved documents, are inherently ambiguous, often lack specificity, and it is difficult to capture the accurate semantic meaning to generate the target code snippets. Thus, it would be beneficial to boost the performance of such retrieval-augmented code generation mechanisms by generating the code snippets, not only based on the input natural language instruction, but also based on reference code snippets which are similar to the target code. In addition, generating code based on reference code snippets can make sure the process operates within the strict formal rules of programming languages, ensuring outputs are syntactically correct.

With the mechanisms of the illustrative embodiments, an end-to-end multi-source retrieval-augmented code generation computing tool and corresponding operations/functionality are provided, which solve the limitations of these types of retrieval-augmented code generators. The end-to-end multi-source retrieval-augmented code generator of the illustrative embodiments includes a processing pipeline that operates based on a text-code pairwise retrieval pool and a multi-source retrieval process. First, the proposed pipeline utilizes a pairwise retrieval pool which comprises pairings of text descriptions of source code and the corresponding source code to ensure that the pipeline's retrieval process retrieves natural language text references based on the natural language of the input, which provides high retrieval accuracy. Moreover, the paired source code is used as a template or source for generating the source code corresponding to the input natural language description of the intended code functionality. This improves the code generation. Thus, by using both the text description based identification and the paired source code, the code generation accuracy is improved.

FIG. 1C is an example conceptual diagram of an operation of a multi-source retrieval-augmented code generator in accordance with one illustrative embodiment. The example shown in FIG. 1C combines the advantage sides of FIGS. 1A and 1B, as well as avoid the drawback of both, to enhance the code generation performed by the pipeline of the multi-source retrieval-augmented source code generator. As shown in FIG. 1C, the input natural language description of the source code to be generated, i.e., input x 110, is used to identify similar natural language descriptions, summaries, or other metadata 162 describing a snippet of source code 164 that is paired with that text 162, i.e., input x is used to search for similar text x′ 162 in the pairwise retrieval pool 160. The text x′ 162 is paired with a snippet of source code y′ 164 which the text x′ 162 describes. By finding a similar textual description x′ 162 to the input text x 110, the corresponding source code y′ 164 is found and is more accurate than if a search of source code y′ 164 were performed directly (as in FIG. 1A above). The corresponding source code y′ 164 may then be used as a template for the generated source code 170 by replacing portions of the source code y′ 164 with elements extracted from the input x 110.

In this way, compared with FIG. 1A, the illustrative embodiments retrieve the relevant code by comparing between two natural language items instead of comparing between natural language and code snippets, which have different language forms, thus improving the retrieval performance. Compared with FIG. 1B, the illustrative embodiments generate the target output code snippets based on one or more relevant reference code snippets instead of being based on only natural language documents/instructions, thus improving the generation performance.

In searching the pairwise retrieval pool 160 of the illustrative embodiments, the searching mechanism may rank the entries of the pairwise retrieval pool 160 based on a scoring of each entry as to its similarity to the search criteria specified in the search, i.e., the key terms and features extracted from the natural language input x 110 in FIG. 1C. These rankings may be used along with thresholds to identify a subset of entries that are sufficiently similar to the search criteria to warrant consideration for use as templates for generating source code. In some cases, a highest ranking or top X ranking set of candidates may be selected for further consideration.

In order to make the process of identifying candidates and selecting a candidate for use in generating a source code output y 170 based on the input x 110 in FIG. 1C, the pipeline of some illustrative embodiments may further provide a multi-source retrieval process that retrieves knowledge data from a variety of sources and utilizes a re-ranking strategy to re-rank the retrieved reference data from the pairwise retrieval pool 160, i.e., the pairs of text and code, based on the knowledge data from these other sources. In this way, the pipeline of the illustrative embodiments can utilize multiple sources of knowledge to boost the source code generation performance by boosting or reducing the scores and/or rankings of pairings based on the evidence provided in other sources.

The searching of the pairwise retrieval pool 160 may be performed based on encodings of the natural language text of both the input and the textual descriptions paired with the reference code snippets. In addition, the sources of knowledge outside the pairwise retrieval pool may also be encoded text. Thus, the encoding of the input may be used to identify similar encoded vectors in the pairwise retrieval pool and the outside knowledge base and the results from each may be used to perform a re-ranking of the pairs to improve the selection of a pairing to use to generate the source code output.

Thus, for example, in some illustrative embodiments, the input natural language description of the computer code functionality that is desired, i.e., input x, is encoded into an encoded representation q(x) by a transformer encoder. This generates a vector representation of the input x. This encoded vector representation q(x) may then be compared to encodings q(x′) of the natural language description portion x′ of the pairs of natural language descriptions x′ and corresponding source code y′ in a pairwise retrieval pool. A vector similarity algorithm, distancing metric, or the like, may be used along with appropriate predetermined thresholds and rankings to generate a set of one or more pairs that are determined to be sufficiently similar to the encoded input q(x). Similarly, the encoded vector representation q(x) may also be used to search for text c′ from an outside knowledge base which is similarly encoded, i.e., q(c′).

Thus, a set of outside knowledge base documents or text c′ is generated and a set of one or more pairs (x′, y′) is generated from the pairwise retrieval pool. These may be input to a re-ranking component that re-ranks the pairings (x′, y′) and text c′ together. Thus, pairings that may have been previously ranked higher than other pairings may have their ranking reduced while other pairings may have their ranking increased relative to the other pairings, and the same to text c'. Essentially, the knowledge base documentation or text c′ provides further features that are indicative of whether or not particular types of source code are good candidates or not for particular types of functionality. Hence, while the search of the pairwise retrieval pool will identify pairs that have sufficiently high similarity to the input x, the additional documentation and text c′ provides a way to differentiate between the sufficiently similar pairs to provide even higher accuracy results. All of this results in the finally selected reference source code y′ that is used as a template and reference document c′ as further assisted semantic knowledges for generating the source code output y being highly accurate to the intent of the user as specified in the input x.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a multi-source retrieval-augmented code generator and corresponding operations/functionality. The improved computing tool implements mechanism and functionality, such as transformer based encoding of input textual descriptions of intended source code functionality, pairwise retrieval pool implementations and encodings, encoding of outside knowledge base text, re-ranking of pairings from pairwise retrieval pool based on the evidence in the outside knowledge base text, and automated generation of source code based on the re-ranked pairings of text and reference source code snippets, which cannot be practically performed by human beings either outside of, or with the assistance of, a technical environment, such as a mental process or the like. The improved computing tool provides a practical application of the methodology at least in that the improved computing tool is able to automatically, and through artificial intelligence based mechanisms, generate source code from a natural language description of an intended computer code functionality.

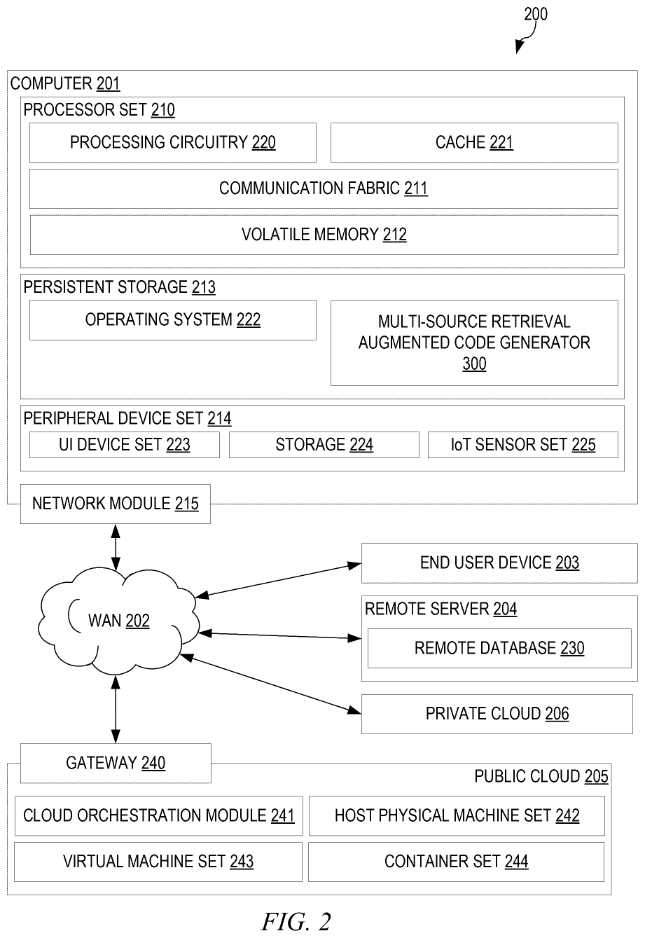

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as a multi-source retrieval-augmented code generator 300. In addition to multi-source retrieval-augmented code generator 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and multi-source retrieval-augmented code generator 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in multi-source retrieval-augmented code generator 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in multi-source retrieval-augmented code generator 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a multi-source retrieval-augmented code generator 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated artificial intelligence based source code generation from natural language specifications of computer code functionality.

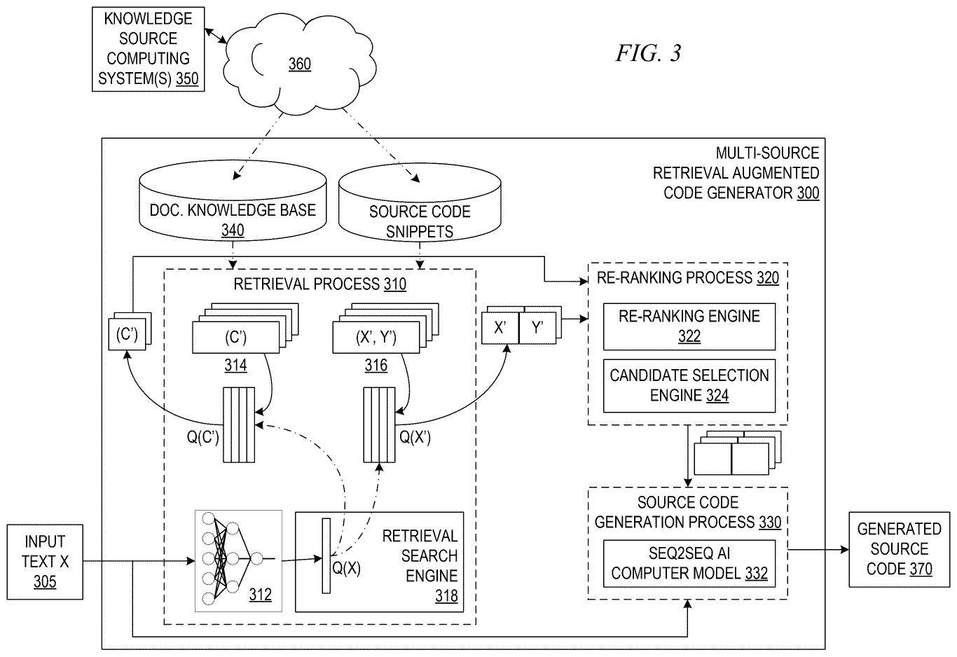

FIG. 3 is an example block diagram illustrating the primary operational components of a multi-source retrieval-augmented code generator in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that retrieval-augmented code generation is performed, and providing a specific solution that implements a computing pipeline comprising a pairwise retrieval pool and external documentation pool based retrieval process, a re-ranking process, and a source code generation process, which cannot be practically performed by human beings as a mental process and is not directed to organizing any human activity.

As shown in FIG. 3, the multi-source retrieval-augmented code generator 300 comprises a pipeline of components associated with three main processes performed by the pipeline, i.e., a retrieval process 310, a re-ranking process 320, and a source code generation process 330. The components associated with the retrieval process 310 include a transformer encoder 312, a document retrieval pool 314, a pairwise retrieval pool 316, and a retrieval search engine 318. The pairwise retrieval pool 316 stores pairings of text and corresponding source code snippets that are described by the paired text. The text and source code for generating these pairings may be collected from public repositories and online coding platforms, for example. The public repositories may store code with comments, such as in the case of GitHub or GitLab. The online coding platforms may store information regarding problem descriptions (text) and solutions (code) from platforms, such as Stack Overflow, LeetCode, or Codewars. The text portions of the pairings may be normalized by standardizing the text through removal of irrelevant information, correcting spelling and grammar errors, converting text to a consistent format (e.g., lowercase), and the like. The code formatting for the code portions of the pairings may also be standardized and corrected as necessary to ensure that the code snippets are properly formatted. In some cases, the resulting pairings may be filtered to remove low-quality pairs where the text is not a good match for the code. This may be done by performing a similarity analysis between the text portion and the code portion, such as using CodeBERT or the like, for example.

The document retrieval pool 314 may comprise a diverse set of documents and portions of text that are pertinent to the generation of source code from natural language descriptions. For example, the document retrieval pool 314 may comprise textual content obtained from tutorials for programming languages that specify patterns or high-level guidance. The documents in the document retrieval pool 314 are not limited to such tutorials and may include other documents and portions of text from any of a plurality of different source computing systems. By including the evaluation of such text in addition to the pairings of text and code snippets in the pairwise retrieval pool 316, while the pairwise retrieval pool 316 provides specific, context-sensitive examples, the documents in the document retrieval pool 314 provide a higher level of guidance that can be used to differentiate between the various contexts when selecting examples for use in generating source code. This improves the accuracy of the generated source code 370 as well as increases the chances of covering edge cases or uncommon scenarios.

The transformer encoder 312 operates to encode natural language text into vector representations using a transformer-type artificial intelligence (AI) computer model trained to perform this functionality. The transformer encoder 312 may use dense embeddings, for example, which map a portion of text into a high dimensional space of real numbers that considers the semantic relationships and contextual information of the text input. Transformer AI computer models are generally known in the art and thus, a more detailed explanation of such computer models is not provided herein.

As shown in FIG. 3, the transformer encoder 312 may be a single encoder. However, in some illustrative embodiments, a dense passage retrieval (DPR) approach may be utilized in which a dual-encoder framework is used, one encoder being used to encode the input natural language text (x) 305 and another encoder being used to encode passages, which in this case is the text from the documents (c′) in the document retrieval pool 314 and the text portion (x′) of the pairings in the pairwise retrieval pool 316. It should be appreciated that while a transformer encoder 312 is utilized in the description of the illustrative embodiments, the illustrative embodiments are not limited to such and any other encoding mechanism may be used to represent the input text in a format that can be used to perform similarity analysis between different portions of text by computing tools.

As noted above, the transformer AI computer model 312 outputs an encoding of the input natural language text, such that the encoding represents the natural language text as one or semantic vector representations. The transformer encoder 312 may operate on input natural language text (x) 305, documents or portions of text in the document (c′) retrieval pool 314, and textual descriptions, summaries, and metadata (x′) in the pairings stored in the pairwise retrieval pool 316 to generate corresponding encodings or vector representations q(x), q(c′), and q(x′), respectively.

The input (x) 305 is received by the transformer encoder 312 which generates an encoding q(x) that is provided to the retrieval search engine 318. The retrieval search engine 318 performs a search for matching encodings in the document retrieval pool 314 and pairwise retrieval pool 316. The matching is determined by calculating similarity scores between the encodings using a suitable vector similarity or distance function. The similarity scores may be used by the retrieval search engine 318 to rank the entries in the document retrieval pool 314 and the pairwise retrieval pool 316 relative to one another and then select a set of entries from each pool 314 and 316 for submission to the re-ranking process 320. In some cases, one or more thresholds of similarity may be defined and may indicate a minimum level of similarity required for the corresponding text to be sufficiently similar to the input text (x) 305 to warrant further consideration by the pipeline. These thresholds may be used along with the rankings to select the set of entries from each pool 314 and 316, and thereby generate the set of documents 315 and set of pairings 317 that are output to the re-ranking process 320.

The re-ranking process 320 is performed by a re-ranking engine 322 and candidate selection engine 324. The re-ranking engine 322 generates an updated ranking of candidate pairings based on the retrieved outside documents from the document knowledge base 340. The document knowledge base 340 may comprise documents, portions of text, and the like, from a variety of different source computing systems 350 via one or more data networks 360. The documents in the document retrieval pool 314 provide additional evidence that may describe additional factors for evaluating the ranking of pairings stored in the pairwise retrieval pool 316 and which may serve as a basis for the re-ranking of these pairings when selecting pairings for use in generating source code.

The candidate selection engine 324 selects a candidate pairing from the re-ranked listing of candidate pairings, for use by the generation process 330. The generation process 330 comprises a pre-trained sequence-to-sequence (seq2seq) AI computer model 332 that takes the input text (x) 305 and the selected candidate source code and generates, given these inputs, a sequence of characters corresponding to the source code that performs the requested functionality set forth in the input text (x) 305. The generated code y 370 may then be output as part of computer executable code that may be used to generate an application for execution.

It should be appreciated that in some illustrative embodiments, the document retrieval pool 314 may not be utilized. That is, the matches may be determined by the retrieval search engine 318 only based on the entries (i.e., pairings) in the pairwise retrieval pool 316. In such a case, the similarity scores may be used to rank the entries in the pairwise retrieval pool 316 and a corresponding set 317 of one or more entries may be selected, e.g., those above a given threshold similarity score requirement, a top X ranked entries, or the like. In the case where the document retrieval pool 314 is not utilized, then the re-ranking 322 may be bypassed and the set 317 of entries from the pairwise retrieval pool 316 may be provided directly to the candidate selection engine 324 followed by the generation process 330 for use in generating the source code output y 370.

Thus, as shown in FIG. 3, as described above, the retrieval-augmented code generation pipeline has three main processes, i.e., the retrieval process 310,the re-ranking process 320, and the generation process 330. The retrieval process takes the natural language input 305, e.g., an instruction or other textual description of the intended functionality of the generated code 370, as the input x 305 and aims to retrieve the relevant reference data set {(x′_1,y′_1)...(x′_N, y′_K)} and {c_1..., c_K} from multiple sources of knowledge. In the illustrative embodiments, these multiple sources of knowledge include two data sources to retrieve from, i.e., a text-code pairwise data source {(x′_1, y′_1)...(x′_N, y′_N)} referred to as the pairwise retrieval pool 316, which contains N samples, and documents data sources {c_1..., c_M}, which are M texts collected from various source computing systems, referred to as the document retrieval pool 314. In some illustrative embodiments, the documents in the document retrieval pool 314 may be collected from tutorials of the relevant program language (e.g., Python, Java, or the like) which is to be used to generate the source code output 370.

The transformer encoder 312 calculates the embedding of the input x 305, as well as the text part x′ in each text-code pairwise data sample. In some illustrative embodiments, a DPR process is utilized to rank these text-code pairs based on the relevance between x and x′, and then the top-K samples are selected. Similarly, a DPR process is used to retrieve the top-K relevant documents or text from the document retrieval pool 314. Again, in some illustrative embodiments where the document retrieval pool 314 and re-ranking is not utilized, then the DPR process is performed only on the text-code pairs and the top-K samples are selected as the set 317 for use in selecting a candidate to be used by the generation process 330.

Assuming a re-ranking process 320 is performed, given the top-K pair data samples 317 {(x′_1,y'_1)...(x′_N, y′_K)} and the top-K documents set 315 {c_1..., c_K}, these samples and documents are mixed and re-ranked. In some illustrative embodiments, when performing the re-ranking, each reference data sample is combined with the input data x, and input together to a transformer-type re-ranking computer model of the re-ranking engine 322. Cross attention is applied over the tokens of both x and x′, as well as both x and c. The encoded vector representations for the retrieved data x′, c′ and input data x are produced independently. By using an interaction model of the re-ranking engine 322, the re-ranking engine 322 is able to re-rank the top-P retrieved data samples.

In some illustrative embodiments, the interaction model of the re-ranking engine 322 is based on a sequence-pair classification BERT transformer, for example. The input data x and each retrieved data are input together to a BERT transformer. The representation vectors for the input data x and each retrieved data are produced jointly. By using an interaction model to re-rank the passages from a representation model, one can get the advantages of both model types: accuracy and scalability.

Given the retrieved data x′, c′ of the top-P retrieved data samples, the source code generation process 330 combines them with the input data x 305 to generate the target source code based on an encoder-decoder generator, e.g., seq2seq AI computer model 322. For the retrieved data from pairwise retrieval pool 316, the input is (x, y′) so as to only include the code part of the retrieved data for the top-P data samples. For the retrieved documents in the top-P retrieved data samples, the input to the seq2seq AI computer model 332 is (x, c′). When each token is generated by the seq2seq AI computer model 332, either the token-based or sequence-based way for decoding from retrieval augmented generation (RAG) is adopted. In token-based decoding, the model generates the output one word (token) at a time, considering the retrieved context and what it has generated so far. This is like building a sentence step-by-step. In sequence-based decoding, the model generates or selects entire sentences or answers at once based on the retrieved context, and then picks the best one. Token-based decoding is more flexible but slower, so it is better to use when the target generated code is not too long and has high variability. Sequence-based decoding is faster so it is more suitable to systems which requires a faster response.

Thus, the illustrative embodiments provide an improved computing tool and improved computing tool operations/functionality that leverages context-sensitive pairing examples of text and source code snippets, with general patterns and higher-level guidance of documents from multiple sources, to generate source code corresponding to a natural language description of the functional intent. The illustrative embodiments provide mechanisms for re-ranking the reference pairings of text and source code snippets which allows for the prioritization of the most relevant examples from the pairwise retrieval pool and filtering out of less relevant or low-quality examples. Moreover, the re-ranking assists in optimizing the use of computational resources by focusing on the most promising examples. The re-ranking process ensures that the pipeline remains performant even as the retrieval pools 314 and 316 grow.

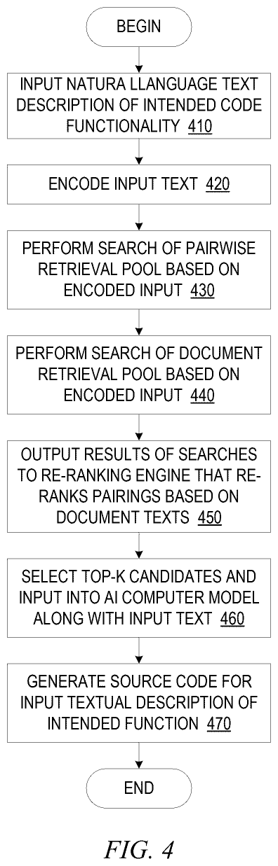

FIG. 4 presents a flowchart outlining example operations of elements of the present invention with regard to one or more illustrative embodiments. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts by receiving an input natural language textual description of an intended code functionality to be performed by an automatically generated source code (step 410). This input is encoded (step 420) and the encoding is used as a basis to search a pairwise retrieval pool by performing a vector similarity evaluation and scoring based on an encoding of the text portion of each pairing in the pairwise retrieval pool (step 430). The encoding is also used as a basis to search a document retrieval pool to evaluate vector similarity and perform similarity scoring based on an encoding of the text of the documents (step 440). The results of the searches of the pools are output to a re-ranking engine which re-ranks the similar pairings based on the similar document text (step 450). The top-K candidates are then selected for use (step 460) and are input along with the original input text to a source code generation AI computer model, e.g., a seq2seq computer model, to generate an output the automatically generated source code for the input (step 470). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
creating a pairwise data source as a pairwise retrieval pool, wherein each data sample includes a pairing of a textual description and a corresponding relevant source code snippet;
encoding, via an encoder, an input natural language text description of an intended code functionality, to thereby generate an input encoding;
searching the pairwise retrieval pool for one or more candidate data samples based on the input encoding and encodings of the textual descriptions of the data samples;
selecting a candidate data sample from the one or more candidate data samples for use in generating output source code; and
generating the output source code based on the selected candidate data sample and the input natural language text description.

2. The method of claim 1, wherein the relevant source code snippet of the selected candidate data sample is used as a template for generating the output source code, and wherein portions of the template are replaced or populated based on features extracted from the input natural language text description of the intended code functionality.

3. The method of claim 1, wherein the pairings of textual description and corresponding relevant source code snippet are generated from at least one of public repositories comprising source code and source code comments, and online coding platforms that store information about problem descriptions of problems to be solved and corresponding code that are solutions to the corresponding problems.

4. The method of claim 1, wherein the encoding of the input natural language description is performed by a transformer artificial intelligence computer model to generate the input encoding as a first vector, and wherein the encodings of the textual descriptions of the data samples is performed by the transformer artificial intelligence computer model to generate second vectors.

5. The method of claim 4, wherein searching the pairwise retrieval pool comprises:
performing a vector similarity analysis between the first vector and each second vector to generate the one or more candidate data samples; and
selecting the candidate data sample form the one or more candidate data samples based on relative vector similarity scores generated by the vector similarity analysis for each pairing of first vector and second vector.

6. The method of claim 1, further comprising searching a documents retrieval pool for one or more candidate natural language text portions based on the input encoding and encodings of natural language text in the documents retrieval pool, wherein the documents retrieval pool stores encodings of natural language text from documents describing source code generation, wherein the selection of the candidate data sample from the one or more candidate data samples is performed based on the one or more candidate natural language text portions.

7. The method of claim 6, wherein the documents describing source code generation are tutorials for programming languages that specify patterns and guidance for programming in the programming languages.

8. The method of claim 6, wherein the one or more candidate data samples modify a relative ranking of the one or more candidate data samples.

9. The method of claim 1, wherein generating the output source code based on the selected candidate data sample and the input natural language text description comprises processing the selected candidate data sample and the input natural language text description by a sequence-to-sequence artificial intelligence computer models that generates a sequence of characters corresponding to source code that performs the requested functionality set forth in the input natural language text description.

10. The method of claim 1, wherein selecting the candidate data sample from the one or more candidate data samples comprises scoring each candidate data sample of the one or more candidate data samples based on the input encoding and an encoding of the candidate data sample, ranking the one or more candidate data samples relative to one another, and selecting a top ranked candidate data sample from the one or more candidate data samples.

11. A computer program product comprising:
one or more computer-readable storage media; and
program instructions stored on the one or more computer-readable storage media to perform operations comprising:
creating a pairwise data source as a pairwise retrieval pool, wherein each data sample includes a pairing of a textual description and a corresponding relevant source code snippet;
encoding, via an encoder, an input natural language text description of an intended code functionality, to thereby generate an input encoding;
searching the pairwise retrieval pool for one or more candidate data samples based on the input encoding and encodings of the textual descriptions of the data samples;
selecting a candidate data sample from the one or more candidate data samples for use in generating output source code; and
generating the output source code based on the selected candidate data sample and the input natural language text description.

12. The computer program product of claim 11, wherein the relevant source code snippet of the selected candidate data sample is used as a template for generating the output source code, and wherein portions of the template are replaced or populated based on features extracted from the input natural language text description of the intended code functionality.

13. The computer program product of claim 11, wherein the pairings of textual description and corresponding relevant source code snippet are generated from at least one of public repositories comprising source code and source code comments, and online coding platforms that store information about problem descriptions of problems to be solved and corresponding code that are solutions to the corresponding problems.

14. The computer program product of claim 11, wherein the encoding of the input natural language description is performed by a transformer artificial intelligence computer model to generate the input encoding as a first vector, and wherein the encodings of the textual descriptions of the data samples is performed by the transformer artificial intelligence computer model to generate second vectors.

15. The computer program product of claim 14, wherein searching the pairwise retrieval pool comprises:
performing a vector similarity analysis between the first vector and each second vector to generate the one or more candidate data samples; and
selecting the candidate data sample form the one or more candidate data samples based on relative vector similarity scores generated by the vector similarity analysis for each pairing of first vector and second vector.

16. The computer program product of claim 11, wherein the operations further comprise searching a documents retrieval pool for one or more candidate natural language text portions based on the input encoding and encodings of natural language text in the documents retrieval pool, wherein the documents retrieval pool stores encodings of natural language text from documents describing source code generation, wherein the selection of the candidate data sample from the one or more candidate data samples is performed based on the one or more candidate natural language text portions.

17. The computer program product of claim 16, wherein the documents describing source code generation are tutorials for programming languages that specify patterns and guidance for programming in the programming languages.

18. The computer program product of claim 16, wherein the one or more candidate data samples modify a relative ranking of the one or more candidate data samples.

19. The computer program product of claim 11, wherein generating the output source code based on the selected candidate data sample and the input natural language text description comprises processing the selected candidate data sample and the input natural language text description by a sequence-to-sequence artificial intelligence computer models that generates a sequence of characters corresponding to source code that performs the requested functionality set forth in the input natural language text description.

20. A computer system comprising:
a processor set;
one or more computer-readable storage media; and
program instructions stored on the one or more computer-readable storage media to cause the processor set to perform operations comprising:
creating a pairwise data source as a pairwise retrieval pool, wherein each data sample includes a pairing of a textual description and a corresponding relevant source code snippet;
encoding, via an encoder, an input natural language text description of an intended code functionality, to thereby generate an input encoding;
searching the pairwise retrieval pool for one or more candidate data samples based on the input encoding and encodings of the textual descriptions of the data samples;
selecting a candidate data sample from the one or more candidate data samples for use in generating output source code; and
generating the output source code based on the selected candidate data sample and the input natural language text description.
